(19) United States
(12) Patent Application Publication
(10) Pub. No.: US 2024/0302060 A1
(43) Pub. Date: Sep. 12, 2024

(54) SOLAR CHIMNEY AND A METHOD FOR VENTILATING A BUILDING USING A SOLAR CHIMNEY

(71) Applicant: NATIONAL UNIVERSITY OF SINGAPORE, Singapore (SG)

(72) Inventors: Jun GONG, Singapore (SG); Kai Xian CHENG, Singapore (SG); Hao LIU, Singapore (SG); Poh Seng LEE, Singapore (SG)

(21) Appl. No.: 18/278,734

(22) PCT Filed: Feb. 21, 2022
(86) PCT No.: PCT/SG2022/050082

§ 371 Date: Aug. 24, 2023

(30) Foreign Application Priority Data
Feb. 26, 2021 (SG) 10202102017R

(51) Int. Cl. F24F 5/00; F03G 6/04; F24F 7/04

(52) U.S. Cl. CPC F24F 5/0046; F03G 6/045; F24F 7/04; F24F 2005/0064

(57) ABSTRACT

A solar chimney is described. The solar chimney comprising: an elongated enclosure configured to provide a fluid passage to receive light from at least one side of the elongated enclosure; and absorbers arranged in a staggered configuration within the fluid passage wherein at least one of the absorbers is offset in a direction along the fluid passage relative to at least one other absorber, each absorber being adapted to absorb energy from the light for heating up fluid in the fluid passage to create an updraft of the fluid. A method of ventilating a building using a solar chimney is also described.

### CROSS-REFERENCE TO RELATED APPLICATIONS

The present application is a national phase entry under 35 U.S.C. § 371 of International Application No. PCT/SG2022/050082, filed Feb. 21, 2022, published in English, which claims the benefit of the filing date of Singapore Patent Application No. 10202102017R, filed Feb. 26, 2021, the disclosures of which are incorporated herein by reference.

### TECHNICAL FIELD

The present disclosure relates to a solar chimney and a method for ventilating a building using a solar chimney.

### BACKGROUND

A solar chimney is a type of solar heating and/or cooling system that may be used to regulate temperature of a building and provide ventilation. An efficiency of a solar chimney is highly dependent on the amount of solar irradiation received by the solar chimney and its dimensions (i.e. its height, its width and an air gap size). A typical solar chimney with a conventional absorber configuration includes a glass cover, an air gap and a solar absorber, where the solar absorber is a single undivided piece of absorber mounted on a wall of a building.

However, this kind of solar chimney does not provide an optimal operating performance. The presence of a thermal boundary layer (i.e. the absorber overlaying the wall of the building) in such a solar chimney causes uneven temperature distribution in a transverse direction within the air gap, resulting in a localised high temperature gradient found near the interface between the air-gap and the absorber. As air flow in the solar chimney is driven by density reduction of air caused by a temperature increment, a velocity distribution of the air flow within the air gap of a solar chimney with such a localised high temperature gradient is therefore uneven. This phenomenon reduces an overall mass flow rate within the solar chimney and weakens its operating performance. The reduction in the overall mass flow rate can be further exacerbated by a possible reverse flow at an outlet of the solar chimney if the solar chimney has a large air gap-to-height ratio.

It is therefore desirable to provide a solar chimney and a method of ventilating a building using a solar chimney which address the aforementioned problems and/or provides a useful alternative. Further, other desirable features and characteristics will become apparent from the subsequent detailed description and the appended claims, taken in conjunction with the accompanying drawings and this background of the disclosure.

### SUMMARY

Aspects of the present disclosure relate to a solar chimney and a method of ventilating a building using a solar chimney.

In accordance with a first aspect, there is provided a solar chimney comprising an elongated enclosure configured to provide a fluid passage to receive light from at least one side of the elongated enclosure; and absorbers arranged in a staggered configuration within the fluid passage wherein at least one of the absorbers is offset in a direction along the fluid passage relative to at least one other absorber, each absorber being adapted to absorb energy from the light for heating up fluid in the fluid passage to create an updraft of the fluid.

By including absorbers arranged in a staggered configuration within the fluid passage of the solar chimney where at least one of the absorbers is offset in a direction along the fluid passage relative to at least one other absorber, relatively more fluid at different positions along the fluid passage can be heated up, thereby improving uniformity of a temperature distribution for heating up the fluid using the absorbers. The improved uniformity of the temperature distribution enhances uniformity of a velocity distribution of the fluid within the fluid passage. The improved uniformity of the temperature and velocity distributions of the fluid in turn improves a mass flow rate of the fluid through the solar chimney. Further, the staggered configuration of the absorbers increases a total contact area between the absorbers and the fluid, thereby enhancing convective heat transfer from the absorbers to the fluid. This reduces surface temperatures of the absorbers and other components of the solar chimney, resulting in a reduction of radiative and convective heat loss of the solar chimney. These factors work synergistically to increase a mass flow rate of the fluid and enhancing an operating efficiency of the solar chimney. The improved uniformity of the temperature and velocity distributions of the fluid in the solar chimney also minimises occurrence of reverse flow at an outlet of the solar chimney.

The absorbers may not be overlapping one another. By not having the absorbers overlapping one another, particularly in a direction of the received light, the solar chimney includes a maximised effective light absorbing area of the absorbers, thereby increasing an operating efficiency of the solar chimney.

Each absorber may be offset in a direction along the fluid passage. This helps to space out the absorbers within the fluid passage to increase an efficiency for convective heat transfer from the absorbers to the fluid.

In accordance with a second aspect, a kit of parts arranged to be assembled to form any preceding solar chimney is described.

In accordance with a third aspect, a method for ventilating a building using a solar chimney is described. The solar chimney comprises an elongated enclosure and absorbers, the elongated enclosure having an inlet fluidly connected to the building and an outlet. The method comprising: configuring the elongated enclosure to provide a fluid passage to receive light from at least one side of the elongated enclosure; and arranging the absorbers in a staggered configuration within the fluid passage wherein at least one of the absorbers is offset in a direction along the fluid passage relative to at least one other absorber, each absorber being adapted to absorb energy from the light for heating up fluid in the fluid passage to create an updraft of the fluid from the inlet, through the fluid passage, and to the outlet for ventilating the building.

The method may comprise arranging the absorbers to be not overlapping one another.

Each absorber may be in a form of a plate and may have a light absorbing area substantially parallel to the at least one side of the elongated enclosure.

The method may comprise arranging each absorber to be offset in a direction along the fluid passage.

A ratio of a length of the elongated enclosure to a separation or a distance between (i) the at least one side of the elongated enclosure and (ii) an opposite side to the at least one side of the elongated enclosure may be in a range of 0.2 to 0.5. The separation or the distance between (i) the at least one side of the elongated enclosure and (ii) the opposite side to the at least one side of the elongated enclosure may be termed as “a fluid gap” or if the fluid is air, “an air gap”. By having the ratio of the length (or longitudinal length) of the elongated enclosure to the fluid gap to be in a range of 0.2 to 0.5, the mass flow rates of the solar chimney having absorbers arranged in a staggered configuration can be improved between 38% to 50% as compared to that of the conventional solar chimney.

The at least one side of the elongated enclosure may be transparent. This transparent side of the elongated enclosure allows light to pass through and be absorbed by the absorbers effectively.

The absorbers may be made of non-reflective metal or concrete. This helps to increase an effective efficiency of the absorbers for absorbing heat from the light source.

The elongated enclosure may include a wall of a building. This reduces material for forming a complete elongated enclosure.

### BRIEF DESCRIPTION OF DRAWINGS

Embodiments of the disclosure will now be described, by way of example only, with reference to the following drawings, in which:

FIG. 1 shows a schematic of a typical structure of a conventional solar chimney;

FIG. 2 shows a schematic of a solar chimney comprising absorbers arranged in a staggered configuration in accordance with an embodiment;

FIG. 3 shows a computational model of a solar chimney illustrating dimensions of the solar chimney used in simulation studies in accordance with an embodiment;

FIG. 4 shows two-dimensional contour plots of air temperature simulated using the computational model of FIG. 3 for the conventional solar chimney of FIG. 1 and the solar chimney of FIG. 2 in accordance with an embodiment;

FIG. 5 shows graphs of simulated air temperatures at different positions in a transverse direction of an air-gap at an outlet of a solar chimney, for the conventional solar chimney of FIG. 1 and the solar chimney with staggered absorbers of FIG. 2, in accordance with an embodiment;

FIG. 6 shows two-dimensional contour plots of air velocity simulated using the computational model of FIG. 3 for the conventional solar chimney of FIG. 1 and the solar chimney of FIG. 2 in accordance with an embodiment;

FIG. 7 shows graphs of simulated air velocity in a direction along the air passage versus a position along a transverse direction of an air-gap at an outlet of a solar chimney, for the conventional solar chimney of FIG. 1 and the solar chimney with staggered absorbers of FIG. 2, in accordance with an embodiment;

FIG. 8 shows a computational model of a solar chimney with extended computational domains around an inlet and an outlet of the solar chimney for use in further simulation studies in accordance with an embodiment;

FIG. 9 shows two-dimensional contour plots of air temperature simulated using the computational model of FIG. 8 for the conventional solar chimney of FIG. 1 and the solar chimney of FIG. 2 in accordance with an embodiment;

FIG. 10 shows graphs of simulated air temperatures at different positions in a transverse direction along an air-gap at an outlet of a solar chimney, for the conventional solar chimney of FIG. 1 and the solar chimney with staggered absorbers of FIG. 2, in accordance with an embodiment;

FIG. 11 shows two-dimensional contour plots of air velocity simulated using the computational model of FIG. 8 for the conventional solar chimney of FIG. 1 and the solar chimney of FIG. 2 in accordance with an embodiment; and

FIG. 12 shows graphs of simulated air velocity in a direction along the air passage versus a position along a transverse direction of an air-gap at an outlet of a solar chimney, for the conventional solar chimney of FIG. 1 and the solar chimney with staggered absorbers of FIG. 2, in accordance with an embodiment.

### DESCRIPTION

The following description is merely exemplary in nature and is not intended to limit the disclosure or the application and uses of the disclosure. Furthermore, there is no intention to be bound by any theory presented in the preceding background or the following description.

Exemplary embodiments relate to a solar chimney comprising an elongated enclosure configured to provide a fluid passage to receive light from at least one side of the elongated enclosure, and absorbers arranged in a staggered configuration within the fluid passage where each absorber is adapted to absorb energy from the light for heating up fluid in the fluid passage to create an updraft of the fluid.

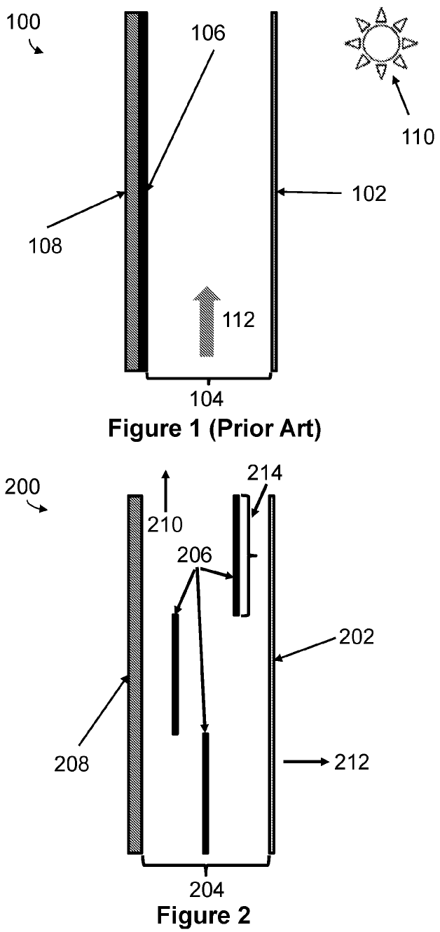

FIG. 1 shows a schematic of a typical structure 100 of a conventional solar chimney for illustrating the working of a solar chimney. FIG. 1 shows a portion of the conventional solar chimney which includes a transparent glass cover 102, an air passage 104 and an absorber 106. The absorber 106 being overlaid on a wall 108 of a building. The working of the solar chimney can be described as follows. Light from the sun 110 travels through the transparent glass cover 102 and is absorbed by the absorber 106. The absorber 106 absorbs solar energy from the sun 110 and in turn heats up air within the air passage 104, by conduction and/or convection. The air within the air passage 104 which is heated up by the absorber 106 becomes relatively lighter (i.e. of lower density) than the ambient air external to the air passage 104. The resulting difference in the air density between the heated air within the air passage 104 and the ambient air generates a buoyancy force, which results in an upward flow 112 of the lower-temperature ambient air from an inlet at a bottom of the solar chimney to an outlet at a top of the solar chimney. This helps to ventilate a building which is fluidly connected to the solar chimney (e.g. at the inlet of the solar chimney). However, as discussed in the background section, such a conventional solar chimney as shown in FIG. 1 has its flaws.

FIG. 2 shows a schematic 200 of a solar chimney comprising absorbers 206 arranged in a staggered configuration in accordance with an embodiment. Similar to the conventional solar chimney as shown in FIG. 1, the solar chimney of FIG. 2 includes a cover 202, an air passage 204 and the absorbers 206. In the present embodiment, the cover 202 is made of transparent glass, and the cover 202 together with at least a wall 208 of a building forms an elongated enclosure which provides the air passage 204. The absorbers 206 within the air passage 204 is each adapted to absorb light which passes through the cover 202 for heating up the air in the air passage 204 to create an updraft of the air through the air passage 204. In contrast to the typical structure of the conventional solar chimney as shown in FIG. 1 which has a continuous, undivided absorber 106 that covers a whole wall of a building, the absorbers 206 of the solar chimney of FIG. 2 are of shorter segments positioned within the air passage 204 and arranged in a staggered configuration, where each of the absorbers 206 is offset in a direction along the air passage 204 relative to one another. The absorbers 206 may be termed “split staggered absorbers” as it appears that the whole absorber 106 of the conventional solar chimney is being split into shorter segments, where each shorter segment is offset relative to one another in a staggered configuration. There are three absorbers 206 as shown in FIG. 2 but a skilled person would appreciate that the number of absorbers and each of their lengths can be varied according to a specific structure and/or a specific requirement of a solar chimney. For example, a solar chimney with a wide air passage (i.e. a large air-gap) can accommodate more absorbers to ensure a good uniformity of temperature distribution, and in turn a more uniform velocity distribution of air flow, within the air passage. The absorbers 206 can be in the form of a plate as shown in FIG. 2. The absorbers 206 may also be made up of a metal or concrete or any material which has a high solar absorptivity and/or is non-reflective.

As shown in FIG. 2, the absorbers 206 are staggered in a manner where they are not overlapping one another, both in a direction 210 along the air passage 204 (i.e. in a longitudinal direction of the air passage 204) and in a direction 212 perpendicular to the direction of the air passage 204 (or perpendicular to a planar surface of the cover 202, i.e. in a transverse direction of the air passage 204). Further, in the present embodiment, each of the absorbers 206 has a light absorbing area 214 substantially parallel or parallel to the cover 202 or a planar surface of the cover 202.

By including absorbers 206 arranged in a staggered configuration within the air passage 204 of the solar chimney as shown in FIG. 2, where at least one of the absorbers 206 is offset in a direction 210 along the air passage 204 relative to at least one other absorber, relatively more air at different positions along the air passage 204 can be heated up using the staggered absorbers 206, thereby improving uniformity of a temperature distribution of the heated air. The improved uniformity of the temperature distribution enhances a velocity distribution of air within the air passage 204. The improved uniformity of the temperature and velocity distributions of air in turn improves a mass flow rate of air through the solar chimney. Further, the staggered configuration of the absorbers 206 increases a total contact area between the absorbers 206 and air, thereby enhancing convective heat transfer from the absorbers to air within the air passage 204. This reduces surface temperatures of the absorbers 206 and other components (e.g. the cover 202) of the solar chimney, resulting in a reduction of radiative and convective heat loss of the solar chimney. These factors work synergistically to increase a mass flow rate of air and enhancing an operating efficiency of the solar chimney. The improved uniformity of the temperature and velocity distributions of air in the solar chimney also minimises occurrence of reverse flow at an outlet of the solar chimney.

To demonstrate an improvement in the temperature distribution, the velocity distribution (e.g. ventilation rate) and the mass flow rate of the air within the air passage 204 as a result of implementing the absorbers 206 in the staggered configuration, computational fluid dynamics (CFD) simulations were performed for both the conventional solar chimney of FIG. 1 and the solar chimney of the present disclosure of FIG. 2 by using a fluid simulation programme, ANSYS Fluent.

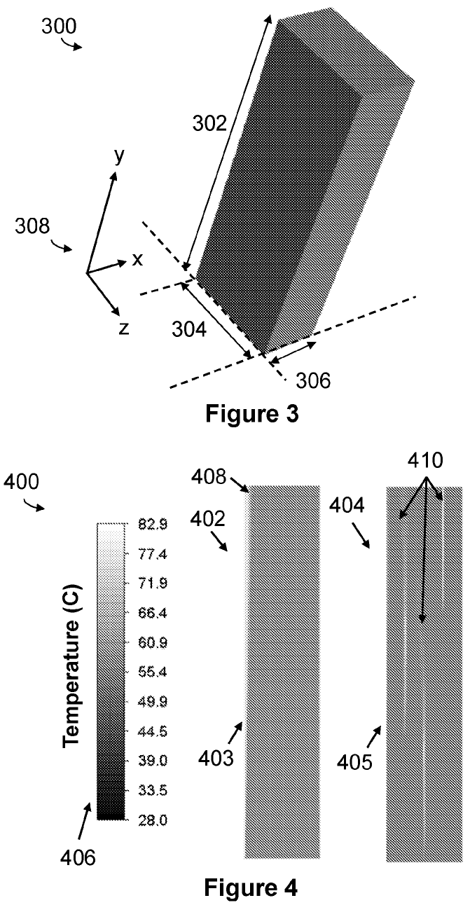

FIG. 3 shows a computational model 300 of a solar chimney used in three-dimensional (3D) CFD simulation studies in accordance with an embodiment. As a typical height of one storey of a building is 2.8 m, a height 302 of 2.8 m is chosen for the solar chimney model 300. A width 304 of the solar chimney model 300 is chosen to be 1 m, while a gap 306 or a separation between the cover and the wall (i.e. a separation of the air passage) is chosen to be 0.56 m in the present simulation studies. The dotted lines shown in FIG. 3 are for guidance only and are not part of the solar chimney model 300. The orientation of the model 300 of the solar chimney in the Cartesian coordinates 308 is also shown in FIG. 3. For the following simulations, the K-Omega Shear Stress Transport (Kω-SST) turbulence model was selected for modelling turbulence, while the Surface-to-Surface radiation model (S2S model) was enabled to account for thermal radiation from solid surfaces of the solar chimney.

Table 1 below shows the 3D CFD simulation results for both the conventional solar chimney of FIG. 1 and the solar chimney of FIG. 2. The gap 306 used in the simulation was 0.56 m.

TABLE 1
3D CFD simulation results of the mass flow rate \dot{m},
average temperature rise ΔT, convective heat transfer to
the air Qₐ and thermal efficiency εₜₕ for the case
of the conventional solar chimney (CSC) of FIG. 1 and the
case of the solar chimney with staggered absorbers of FIG. 2
(split-3ab), with an air gap of 0.56 m.

| type | \dot{m} (kg/s) | ΔT (K) | Qₐ (W) | εₜₕ |
|---|---|---|---|---|
| CSC | 0.125 | 5.5 | 691.6 | 41.2% |
| split-3ab | 0.231 | 3.8 | 874.5 | 52.1% |

As shown in Table 1, by using absorbers arranged in a staggered configuration, the mass flow rate of air in the solar chimney with absorbers in the staggered configuration has increased by 84.8% from 0.125 kg/s to 0.231 kg/s, as compared to the CSC. This is predominately due to the following two reasons. The first reason, also the more critical one, relates to an improved uniformity of a temperature distribution for the heated air using the staggered absorbers. The improved uniformity of the temperature distribution in turn enhances a uniform velocity distribution of the air within the air passage. The second reason relates to a reduction of radiative and convective heat loss by components of the solar chimney to the surroundings. Particularly, configuring the absorbers 206 in a staggered arrangement as shown in FIG. 2 results in an increase in the heat transfer area between the absorbers 206 and air (doubled as compared to the absorber of the conventional solar chimney of FIG. 1) and a re-initialisation of a boundary. These contribute to the reduction of the temperatures of the absorbers 206 and the cover 202 of the solar chimney, thereby reducing radiative and convective heat loss by these components of the solar chimney to the surroundings. These two factors work synergistically to increase the mass flow rate of air within the air passage 204 of the solar chimney with staggered absorbers, increasing its ventilation rate and operating efficiency.

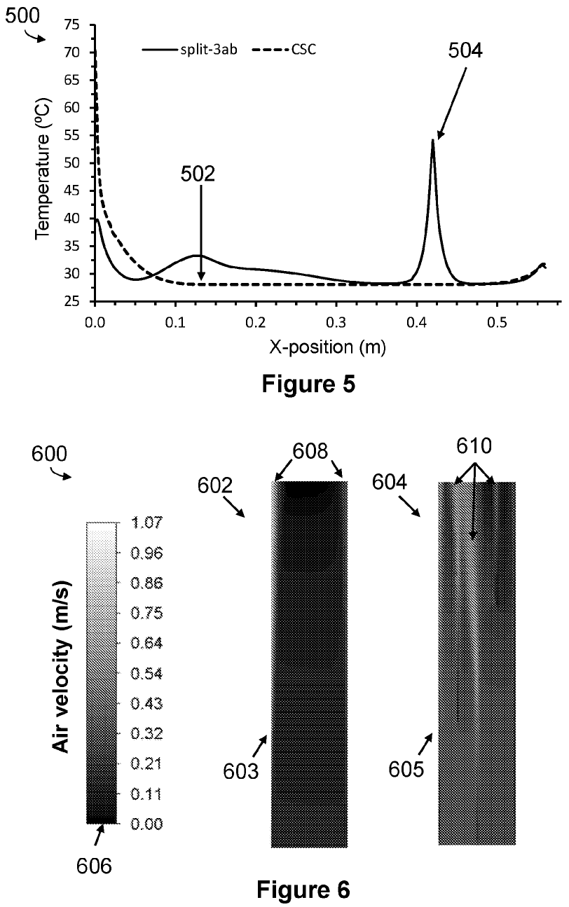

FIG. 4 shows two-dimensional contour plots 400 of air temperature simulated using the computational model 300 of FIG. 3 for the conventional solar chimney of FIG. 1 and the solar chimney of FIG. 2 in accordance with an embodiment. The 2D contour plots 400 were taken at a plane of z=0.5 m (i.e. a x-y plane that cut through a middle of the chimney at z=0.5 m) with reference to FIG. 3. The 2D contour plot 402 relates to the conventional solar chimney of FIG. 1, while the 2D contour plot 404 relates to the solar chimney with staggered absorbers of FIG. 2. For reference, a side 403 of the 2D contour plot 402 marks the side of the conventional solar chimney where the absorber 106 is located, while a side 405 of the 2D contour plot 404 marks the side of the solar chimney with the staggered absorbers where the wall 208 is located. The scale 406 for the temperature contours is also shown in FIG. 4. As shown in the 2D contour plot 402, only a thin layer of air 408 was heated up in the solar chimney with the conventional absorber structure. On the other hand, as shown in the 2D contour plot 404, by using absorbers arranged in the staggered configuration, relatively more air at different positions 410 along the transverse direction of the air passage was heated up. This distributed heating mode improves a uniformity of temperature distribution of air within the air passage of the solar chimney, which is illustrated by FIG. 5.

FIG. 5 shows graphs 500 of simulated air temperatures at different positions in the transverse direction along an air-gap at an outlet (i.e. at the position y=2.8 m) of a solar chimney, for the conventional solar chimney of FIG. 1 and the solar chimney with staggered absorbers of FIG. 2, in accordance with an embodiment. The graphs 500 were taken at a plane of z=0.5 m with reference to FIG. 3. The temperature profile 502 relates to the conventional solar chimney (CSC) of FIG. 1, while the temperature profile 504 relates to the solar chimney with staggered absorbers (split-3ab) of FIG. 2. As shown by the temperature profile 502, static air temperature in the air passage 104 starts with a highest value at the absorber 106 (i.e. at the position x=0 m), decreasing rapidly to an ambient temperature with an increasing distance away from the absorber 106, before increasing subsequently as it approaches the glass cover 102 of the conventional solar chimney. On the other hand, as shown by the temperature profile 504, the outlet air temperature in the solar chimney with the staggered absorbers fluctuates along the transverse direction of the air passage 204 (i.e. in the x-direction) and peaks at positions where the staggered absorbers exist along the transverse direction within the air passage 204.

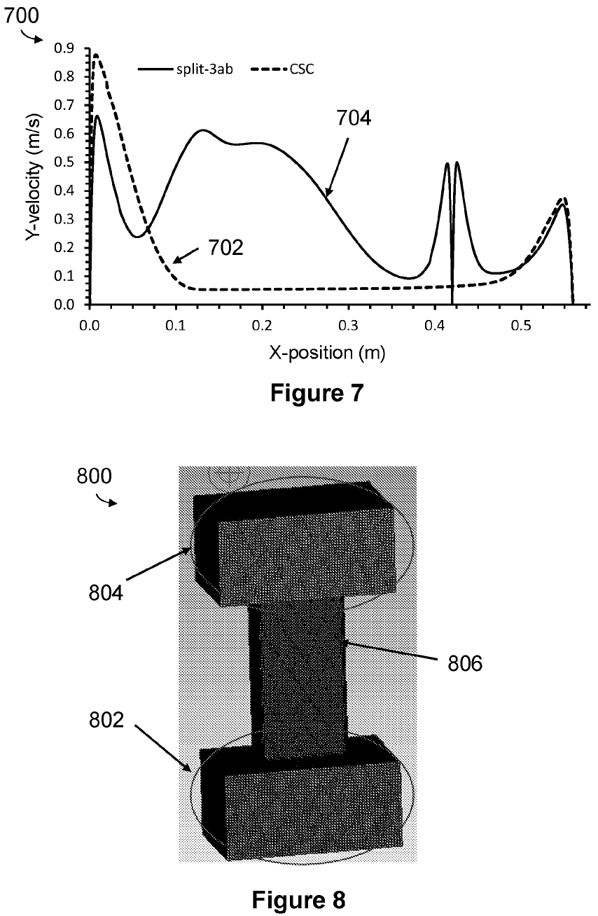

As explained in relation to FIG. 1, natural convection of air within a solar chimney is driven by a buoyancy force resulted from a density difference of the air, which is highly dependent on the air temperatures. As a result, the air velocity field shares a similar profile as its corresponding temperature profile. This is illustrated using the velocity magnitude contours plots and the Y-velocity profile plots of FIGS. 6 and 7, respectively.

FIG. 6 shows two-dimensional (2D) contour plots 600 of air velocity magnitude simulated using the computational model 300 of FIG. 3 for the conventional solar chimney of FIG. 1 and the solar chimney of FIG. 2 in accordance with an embodiment. The 2D contour plots 600 were taken at a plane of z=0.5 m. The 2D contour plot 602 relates to the conventional solar chimney of FIG. 1, while the 2D contour plot 604 relates to the solar chimney with staggered absorbers of FIG. 2. For reference, a side 603 of the 2D contour plot 602 marks the side of the conventional solar chimney where the absorber 106 is located, while a side 605 of the 2D contour plot 604 marks the side of the solar chimney with the staggered absorbers where the wall 208 is located. The scale 606 for the air velocity magnitude is also shown in FIG. 6. As shown in the 2D contour plot 602, thin layers 608 of relatively faster air flows were observed near regions of the absorber 106 and the glass cover 102 of the conventional solar chimney of FIG. 1. On the other hand, as shown in the 2D contour plot 604, by using absorbers arranged in the staggered configuration, relatively more air at different positions 610 along the transverse direction of the air passage 204 had a relatively faster air flow (i.e. air flow with a higher magnitude of air velocity). The improved uniformity of the temperature distribution of air within the air passage 204 of the solar chimney with the staggered configuration thereby results in an improved uniformity of velocity of air flow within the air passage 204.

FIG. 7 shows graphs 700 of simulated air velocity in a direction along the air passage (i.e. in the y-direction as shown in FIG. 3) versus a position along a transverse direction of the air passage (i.e. in the x-direction as shown in FIG. 3) at an outlet (i.e. at the position y=2.8 m) of a solar chimney, for the conventional solar chimney of FIG. 1 and the solar chimney with staggered absorbers of FIG. 2, in accordance with an embodiment. The graphs 700 were taken at a plane of z=0.5 m with reference to FIG. 3. The air velocity profile 702 relates to the conventional solar chimney (CSC) of FIG. 1, while the air velocity profile 704 relates to the solar chimney with staggered absorbers (split-3ab) of FIG. 2. As discussed above, it is expected that the air velocity profiles 702, 704 to be similar to the respective air temperature profiles 502, 504 for the respective solar chimneys. As shown by the air velocity profile 702, a magnitude of the air velocity also starts with a highest value of air velocity at the absorber 106 (i.e. at the position x=0 m), decreasing rapidly with an increasing distance away from the wall 108 of the building, before increasing subsequently as it approaches the glass cover 102. On the other hand, as shown by the air velocity profile 704, the air velocity in the solar chimney with the staggered absorbers fluctuates along the transverse direction of the gap (i.e. the x-direction), peaking around positions where the staggered absorbers exist along the transverse direction of the air passage 204. As shown in FIG. 7, it is clear that the velocity distribution of air flow in the solar chimney with staggered absorbers is more uniform when compared to that of the conventional solar chimney.

In addition to an improvement in the uniformity of temperature and velocity distributions as shown in relation to FIGS. 4 to 7 above, the reduction in heat loss also contributes to the enhancement of mass flow rate in the solar chimney. Although simulations for both the conventional solar chimney and the solar chimney with staggered absorbers were performed using the same environment conditions such as (a) solar irradiation (600 W/m²), (b) convective heat loss coefficient and (c) exterior radiation temperature, the resultant convective heat transfers to the air \dot{q}ₐ (i.e., \dot{m}cₚΔT) were different for these two cases. As shown in Table 1, \dot{Q}ₐ increased from 691.6 W for the conventional solar chimney to 874.5 W for the solar chimney with staggered absorbers. This means less heat loss and a larger thermal efficiency were achieved for the solar chimney with staggered absorbers as compared to the conventional solar chimney. This can be further explained by the temperature of each components of a solar chimney as shown in Table 2 below.

TABLE 2
Area-average temperatures of the components
of a solar chimney with an air gap of 0.56 m.

area-average temperature (° C.)

| item | CSC | split-3ab |
|---|---|---|
| absorber | 79.0 | 55.8, 59.3, 59.3 |
| room wall | 79.0 | 47.8 |
| glass | 35.6 | 33.1 |

As shown in Table 2, the area-average temperature of each of the components of the solar chimney with the staggered absorbers is less than that of the conventional solar chimney. An increase in the heat transfer area and a re-initialisation of a boundary derived from the staggered arrangement of the absorbers 206 contribute to the reduction of the temperatures of the absorbers and the cover of the solar chimney. The lower temperatures of these components of the solar chimney with staggered absorbers result in less radiative and convective heat loss from the glass cover, the inlet and the outlet of the solar chimney.

FIG. 8 shows a computational model 800 of a solar chimney with extended computational domains around an inlet and an outlet of the solar chimney for use in further simulation studies in accordance with an embodiment. Compared to the computational model 300 of FIG. 3, extended computational domains 802, 804 (indicated by the ovals in FIG. 8) were included below an inlet and above an outlet of the solar chimney 806 to account for entrance and exit effects of the solar chimney 806. Zero total pressure and zero static pressure were used as boundary conditions at the surfaces of the lower extended domain 802 (i.e. extended domain below the inlet) and the upper extended domain 804 (i.e. extended domain above the outlet), respectively. Further, as compared to the simulation studies described in relation to FIGS. 4 to 7, these further simulation studies using the computational model 800 included a varying gap-to-height ratio of the solar chimney 806. Particularly, in the earlier simulation studies performed in relation to FIGS. 4 to 7, an air gap 306 of 0.56 m was used for the 2.8 m high solar chimney, which corresponded to a gap-to-height ratio of 0.2. In other words, a ratio of a length of the elongated enclosure of the solar chimney (e.g. a height of the solar chimney) to a width of the air passage 104, 204 (i.e. a separation between the glass cover 102 and the absorber 106 or a separation between the cover 202 and the wall 208) was 0.2. In these further studies, simulations were performed with 2.8 m high solar chimneys having various air gap sizes (e.g., 0.56 m, 0.84 m, 1.12 m and 1.4 m) which corresponded to gap-to-height ratios of 0.2, 0.3, 0.4 and 0.5, respectively.

TABLE 3
3D simulation results of the mass flow rate \dot{m}, average
temperature rise ΔT, convective heat transfer to the air Qₐ and thermal
efficiency εₜₕ for the case of the conventional solar chimney
(CSC) of FIG. 1 and the solar chimney with staggered absorbers
of FIG. 2 (split-3ab), with an air gap of 0.84 m.

| type | \dot{m} (kg/s) | ΔT (K) | Qₐ (W) | εₜₕ |
|---|---|---|---|---|
| CSC | 0.201 | 3.8 | 771.5 | 45.9% |
| split-3ab | 0.301 | 3.1 | 927.7 | 55.2% |

The induced mass flow rate m, the average temperature rise ΔT, the convective heat transfer to the air Qₐ and the thermal efficiency εₜₕ of the CSC and the solar chimney with staggered absorbers for the case of an air gap of 0.84 m are shown in Table 3. By having absorbers arranged in the staggered configuration, the mass flow rate of the solar chimney of FIG. 2 increases by around 50% from 0.201 to 0.301 kg/s as compared to the CSC. This is due to improvements in uniformity of the temperature and velocity distributions of air within the solar chimney as well as a reduction in heat loss by components of the solar chimney, as explained in relation to FIGS. 3 to 7 above.

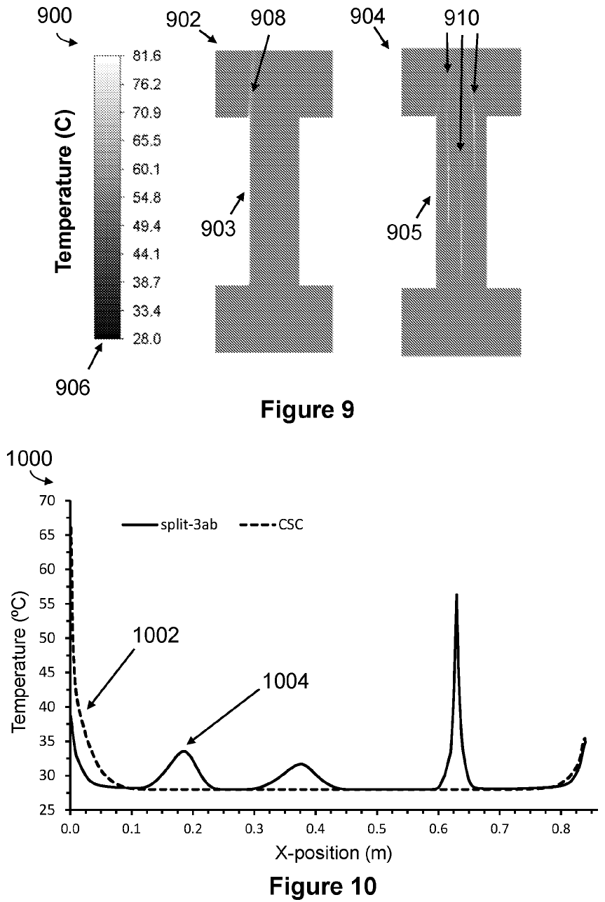

FIG. 9 shows two-dimensional (2D) contour plots 900 of air temperature simulated using the computational model 800 of FIG. 8 for the conventional solar chimney of FIG. 1 and the solar chimney of FIG. 2, in accordance with an embodiment. Comparing with FIG. 4 of the earlier simulation studies, extended computational domains 802, 804 used in these simulations are shown in these temperature contour plots 900. Similar to FIG. 4, these 2D contour plots 900 were taken at a plane of z=0.5 m (i.e. in an x-y plane that cut through a middle of the chimney). The 2D contour plot 902 relates to the conventional solar chimney of FIG. 1, while the 2D contour plot 904 relates to the solar chimney with staggered absorbers of FIG. 2. For reference, a side 903 of the 2D contour plot 902 marks the side of the conventional solar chimney where the absorber 106 is located, while a side 905 of the 2D contour plot 904 marks the side of the solar chimney with the staggered absorbers where the wall 208 is located. The scale 906 for the temperature contours is also shown in FIG. 9. As shown in the 2D contour plot 902, only a thin layer of air 908 was heated up in the solar chimney with the conventional absorber structure. On the other hand, as shown in the 2D contour plot 904, by using absorbers arranged in the staggered configuration, relatively more air at different positions 910 along the transverse direction of the air passage 204 was heated up. This distributed heating mode improves a uniformity of temperature distribution of air within the air passage of the solar chimney, which is illustrated by FIG. 10.

FIG. 10 shows graphs 1000 of simulated air temperatures at different positions in a transverse direction along air-gaps at an outlet (i.e. at the position y=2.8 m) of the conventional solar chimney of FIG. 1 and at an outlet of the solar chimney of FIG. 2, in accordance with an embodiment. The graphs 1000 were taken at a plane of z=0.5 m. The results shown in the graphs 1000 were simulated at the same outlet position of the solar chimney model 300 as compared to the graphs 500 of FIG. 5, while taking into account effects of the area below the inlet and the area above the outlet of the elongated enclosure using the extended domains as shown in FIG. 8. The temperature profile 1002 relates to the conventional solar chimney (CSC) of FIG. 1, while the temperature profile 1004 relates to the solar chimney with staggered absorbers (split-3ab) of FIG. 2. As shown by the temperature profile 1002, static air temperature in the air passage 104 at the outlet of the conventional solar chimney starts with a highest value at the absorber 106 (i.e. at the position x=0 m), decreasing rapidly to the ambient temperature with an increasing distance away from the absorber 106, before increasing subsequently as it approaches the glass cover 102 of the conventional solar chimney. On the other hand, as shown by the temperature profile 1004, the outlet air temperature in the solar chimney with the staggered absorbers fluctuates along the transverse direction of the air passage 204 (i.e. in the x-direction) and peaks at positions where the staggered absorbers exist along the transverse direction of the air passage 204.

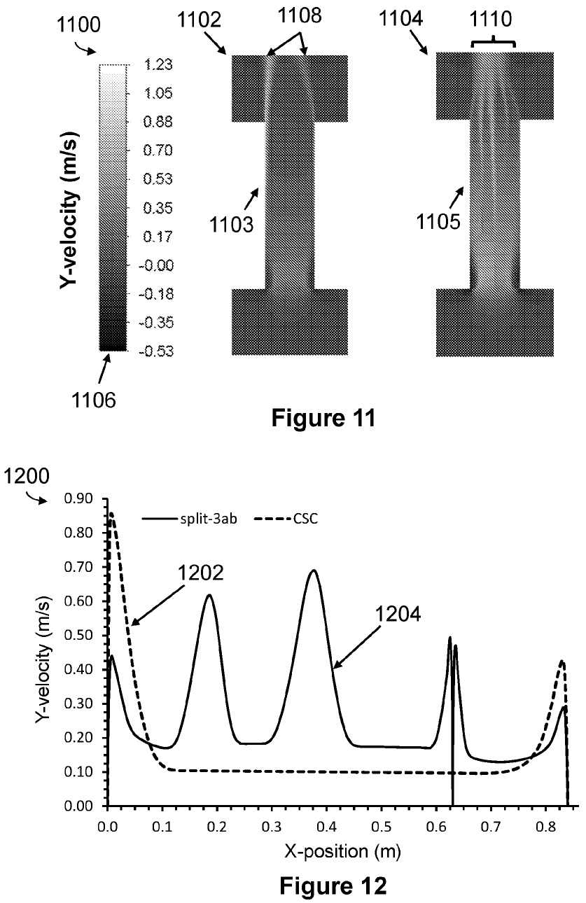

FIG. 11 shows two-dimensional contour plots 1100 of air velocity magnitude simulated using the computational model 800 of FIG. 8 for the conventional solar chimney of FIG. 1 and the solar chimney of FIG. 2, in accordance with an embodiment. Due to the relationship between the air temperature distribution and the air velocity distribution as explained in relation to FIG. 1, the contour plots 1100 of the air velocity magnitude have similar profiles to the contour plots 900 of the static air temperature, as expected. The 2D contour plots 1100 were taken at a plane of z=0.5 m. The 2D contour plot 1102 relates to the conventional solar chimney of FIG. 1, while the 2D contour plot 1104 relates to the solar chimney with staggered absorbers of FIG. 2. For reference, a side 1103 of the 2D contour plot 1102 marks the side of the conventional solar chimney where the absorber 106 is located, while a side 1105 of the 2D contour plot 1104 marks the side of the solar chimney with the staggered absorbers where the wall 208 is located. The scale 1106 for the air velocity magnitude is also shown in FIG. 11. As shown in the 2D contour plot 1102, thin layers 1108 of relatively faster air flow were observed near regions of the absorber 106 and the cover 102 of the conventional solar chimney of FIG. 1. On the other hand, as shown in the 2D contour plot 1104, by using absorbers arranged in the staggered configuration, relatively more air across a transverse profile 1110 of the air passage 204 had a relatively faster air flow (i.e. a higher magnitude of air velocity). The improved uniformity of temperature distribution of air within the air passage of the solar chimney with the staggered configuration thereby results in an improved uniformity of air velocity within the air passage 204.

FIG. 12 shows graphs 1200 of simulated air velocity in a direction along the air passage versus different positions along a transverse direction of an air-gap at an outlet (i.e. at the position y=2.8 m) of a solar chimney, for the conventional solar chimney of FIG. 1 and the solar chimney with staggered absorbers of FIG. 2, in accordance with an embodiment. The graphs 1200 were taken at a plane of z=0.5 m. Similar to FIG. 10, the results shown in the graphs 1200 were simulated at the same outlet position of the solar chimney model 300 as compared to the graphs 700 of FIG. 7, while taking into account effects of the area below the inlet and the area above the outlet of the elongated enclosure using the extended domains as shown in FIG. 8. The air velocity profile 1202 relates to the conventional solar chimney (CSC) of FIG. 1, while the air velocity profile 1204 relates to the solar chimney with staggered absorbers (split-3ab) of FIG. 2. As discussed above, the air velocity profiles 1202, 1204 are expected to be similar to the respective air temperature profiles 1002, 1004 for the respective solar chimneys. As shown by the air velocity profile 1202, a magnitude of the air velocity also starts with a highest value of air velocity at the absorber 106 of the conventional solar chimney of FIG. 1 (i.e. at the position x=0 m), decreasing rapidly with an increasing distance away from the absorber 106, before increasing subsequently as it approaches the glass cover 102. On the other hand, as shown by the air velocity profile 1204, the air velocity in the solar chimney with the staggered absorbers fluctuates along the transverse direction of the air passage 204 (i.e. the x-direction), peaking around the positions where the staggered absorbers exist along the transverse direction of the air passage 204. The magnitudes of the air velocity for the solar chimney with the staggered absorbers are also generally elevated as compared to that for the conventional solar chimney of FIG. 1. This means that the mass flow rate for the solar chimney with the staggered absorbers are also generally elevated as compared to that for the conventional solar chimney.

In addition to the improvement in the uniformity of temperature and velocity distributions, the reduction in heat loss also contributes to the enhancement of the mass flow rate in the solar chimney with staggered absorbers. Although simulations for both the conventional solar chimney and the solar chimney with staggered absorbers were performed using the same environment conditions such as solar irradiation (600 W/m²), convective heat loss coefficient and exterior radiation temperature, the resultant convective heat transfers to the air \dot{Q}ₐ (i.e., \dot{m}cₚΔT) were different. As shown in Table 3, \dot{Q}ₐ has increased from 771.5 W to 927.7 W by using absorbers with the staggered configuration, which means less heat loss and a larger thermal efficiency were achieved for the solar chimney with staggered absorbers as compared to the conventional solar chimney. This can be further explained by the temperature of the components of a solar chimney as shown in Table 4.

TABLE 4
Area-average temperatures of the components
of solar chimney with an air gap of 0.84 m.

area-average temperature (° C.)

| item | CSC | split-3ab |
|---|---|---|
| absorber | 75.3 | 54.2, 57.7, 56.0 |
| room wall | 75.3 | 43.3 |
| glass | 38.5 | 35.8 |

As shown in Table 4, the area-average temperature of each of the components (i.e. the absorbers, the wall and the glass cover) of the solar chimney with absorbers in the staggered configuration is less than that of the conventional solar chimney. An increase in the heat transfer area and a re-initialisation of a boundary derived from the staggered arrangement of the absorbers 206 contributes to the reduction of the temperatures of the absorbers 206 and the cover 202 of the solar chimney with staggered absorbers. The lower temperatures of the components of the solar chimney with staggered absorbers result in less radiative and convective heat loss from its glass cover 202 and openings.

The comparisons in the mass flow rates between the conventional solar chimney and the solar chimney with staggered absorbers are shown in Table 5 for various gap-to-height ratios. Increasing a size of an air gap of a solar chimney with staggered split absorbers can lead to a higher ventilation rate, but at the same time it also occupies more space. Consideration of a gap-to-height ratio for the solar chimney therefore involves a balance between a ventilation rate of a building and an available space. The size of an air gap therefore depends on the specific ventilation requirement of the building (e.g. a large building may require a higher ventilation rate) and an available space for the solar chimney. A range of the gap-to-height ratio of 0.2 to 0.5 has been investigated as shown in the Table 5, taking into account the above considerations.

TABLE 5
Comparison in mass flow rates between the conventional
solar chimney and the solar chimney with staggered
absorbers at various gap-to-height ratios.

| gap-to- | mfr_CSC | mfr_3ab | |
|---|---|---|---|
| height | (kg/s) | (kg/s) | increase |
| 0.2 | 0.171 | 0.237 | 38.3% |
| 0.3 | 0.201 | 0.301 | 50.3% |
| 0.4 | 0.234 | 0.349 | 49.1% |
| 0.5 | 0.263 | 0.390 | 48.1% |

As shown in Table 5, a gap-to-height ratio of 0.2 yields an improvement of around 38.3% by using staggered absorbers as compared to using the conventional absorber configuration in a solar chimney. Such an improvement increases to around 50% for gap-to-height ratios of 0.3, 0.4 and 0.5. The staggered configuration of absorbers in a solar chimney therefore improves a ventilation performance and an efficiency of the solar chimney, especially for a solar chimney with a wide air gap. The solar chimney having staggered absorbers enhances uniformity of air temperature and air velocity distributions, and reduces heat loss for the solar chimney, thereby improving a mass flow rate and in turn its operating efficiency.

It would be appreciated that a solar chimney including absorbers in the staggered configuration will have a number of applications. One of the applications may be to provide ventilation with zero or little energy consumption to a building. The present disclosure therefore includes a method for ventilating a building using a solar chimney comprising an elongated enclosure and absorbers, where the elongated enclosure has an inlet fluidly connected to the building and an outlet. The method comprises: (i) configuring the elongated enclosure to provide a fluid passage to receive light from at least one side of the elongated enclosure; and (ii) arranging the absorbers in a staggered configuration within the fluid passage wherein at least one of the absorbers is offset in a direction along the fluid passage relative to at least one other absorber, each absorber being adapted to absorb energy from the light for heating up fluid in the fluid passage to create an updraft of the fluid from the inlet, through the fluid passage, and to the outlet for ventilating the building. Other applications of the solar chimney may include using the generated air flow in the solar chimney to drive a turbine for generating electricity. Applications of the solar chimney is therefore not limited to ventilating a building as such.

Further, it would be appreciated that the solar chimney can be fabricated on-site (i.e. at a site of the building) or off-site. An embodiment of the solar chimney therefore includes forming a stand-alone elongated enclosure where a wall of the building does not necessarily form a side of the elongated enclosure. It is also envisaged that a kit of the components of the solar chimney can be fabricated off-site and are subsequently provided and assembled on-site to form the solar chimney of the above described embodiments. A skilled person would appreciate that the staggered absorbers may be mounted using one or more sides of the elongated enclosure of the solar chimney. In an embodiment, the staggered absorbers can also be secured to a side of the elongated enclosure which is opposite to the cover, using fastening means (e.g. rods or metal rods).

Alternative embodiments of the solar chimney include: (i) a fluid in the solar chimney where the fluid is a liquid (i.e. not air), the air passage as described above can therefore also be termed as a fluid passage; (ii) varying a number of absorbers in the solar chimney, where the number of absorbers can be in a range between 2 to 20, or between 2 to 10; (iii) varying positions of the absorbers within the fluid passage so that the absorbers are not overlapping in a direction along the fluid passage and/or in a direction perpendicular to the direction along the fluid passage; (iv) varying positions of the absorbers within the fluid passage so that portions of the absorbers are overlapping in a direction along the fluid passage and/or in a direction perpendicular to the direction along the fluid passage; (v) having absorbers being made of a same material or different materials; (vi) having absorbers being not in a form of a plate (e.g. in a spherical or half-spherical shapes); (vii) having absorbers being made of a material with a high absorptivity of light in a solar spectrum, or high absorptivity of light in a visible light spectrum; (viii) having at least one side of the elongated enclosure (e.g. the cover) of the solar chimney being made of a transparent or a translucent material which allows at least some light to pass through; (ix) having the elongated enclosure of the solar chimney which provides the fluid passage to be formed as a stand-alone enclosure; (x) a solar chimney with different dimensions, for example, having a height of 5.6 m and/or a width of 2 m; (xi) having the staggered absorbers being arranged so that at least one of the absorbers is offset relative to at least one other absorber in a direction perpendicular to the direction along the fluid passage; (xii) at least one of the absorbers is offset in a direction along the fluid passage relative to at least one other absorber (in other words, it is not necessary that all the absorbers are offset relative to one another); (xiii) each of the absorbers being offset relative to one another; (xiv) more than one side of the elongated enclosure of the solar chimney is adapted to receive light; (xv) two sides, three sides or all sides of the elongated enclosure of the solar chimney are adapted to receive light; (xvi) more than one side of the elongated enclosure of the solar chimney is transparent or translucent; (xvii) two sides, three sides or all sides of the elongated enclosure of the solar chimney are transparent or translucent; (xviii) the absorbers are angled in relation to the direction along the fluid passage and may be orientated such that the light absorbing area of each of the absorbers is adapted to receive a maximum amount of light; and (xix) a ratio of a length of the elongated enclosure to a separation between the at least one side of the elongated enclosure and an opposite side to the at least one side of the elongated enclosure being in a range of 0.2 to 0.5.

Although only certain embodiments of the present invention have been described in detail, many variations are possible in accordance with the appended claims. For example, features described in relation to one embodiment may be incorporated into one or more embodiments and vice versa.

1. A solar chimney comprising:
an elongated enclosure configured to provide a fluid passage to receive light from at least one side of the elongated enclosure; and
absorbers arranged in a staggered configuration within the fluid passage wherein at least one of the absorbers is offset in a direction along the fluid passage relative to at least one other absorber, each absorber being adapted to absorb energy from the light for heating up fluid in the fluid passage to create an updraft of the fluid.

2. The solar chimney of claim 1, wherein the absorbers are not overlapping one another.

3. The solar chimney of claim 1, wherein each absorber is in a form of a plate and has a light absorbing area substantially parallel to the at least one side of the elongated enclosure.

4. The solar chimney of claim 1, wherein each absorber is offset in a direction along the fluid passage.

5. The solar chimney of claim 1, wherein a ratio of a length of the elongated enclosure to a separation between the at least one side of the elongated enclosure and an opposite side to the at least one side of the elongated enclosure is in a range of 0.2 to 0.5.

6. The solar chimney of claim 1, wherein the at least one side of the elongated enclosure is transparent.

7. The solar chimney of claim 1, wherein the absorbers are made of non-reflective metal or concrete.

8. The solar chimney of claim 1, wherein the elongated enclosure includes a wall of a building.

9. A kit of parts arranged to be assembled to form the solar chimney as claimed in claim 1.

10. A method for ventilating a building using a solar chimney, the solar chimney comprising an elongated enclosure and absorbers, the elongated enclosure having an inlet fluidly connected to the building and an outlet, the method comprising:
configuring the elongated enclosure to provide a fluid passage to receive light from at least one side of the elongated enclosure; and
arranging the absorbers in a staggered configuration within the fluid passage wherein at least one of the absorbers is offset in a direction along the fluid passage relative to at least one other absorber, each absorber being adapted to absorb energy from the light for heating up fluid in the fluid passage to create an updraft of the fluid from the inlet, through the fluid passage, and to the outlet for ventilating the building.

11. The method of claim 10, further comprising arranging the absorbers to be not overlapping one another.

12. The method of claim 10, wherein each absorber is in a form of a plate and having a light absorbing area, further comprising arranging the light absorbing area of each absorber substantially parallel to the at least one side of the elongated enclosure.

13. The method of claim 10, further comprising arranging each absorber to be offset in a direction along the fluid passage.

14. The method of claim 10, wherein a ratio of a length of the elongated enclosure to a separation between the at least one side of the elongated enclosure and an opposite side to the at least one side of the elongated enclosure is in a range of 0.2 to 0.5.

15. The method of claim 10, wherein the at least one side of the elongated enclosure is transparent.

16. The method of claim 10, wherein the absorbers are made of non-reflective metal or concrete.

17. The method of claim 10, wherein the elongated enclosure includes a wall of the building.
